(19) United States
(12) Patent Application Publication
(10) Pub. No.: US 2019/0099812 A1
(43) Pub. Date: Apr. 4, 2019

(54) WORKHOLDING ARBOR FOR GEARS

(71) Applicant: THE GLEASON WORKS, Rochester, NY (US)

(72) Inventors: William A. Curtis, Stanley, NY (US); Patrick R. Piedici, West Henrietta, NY (US)

(21) Appl. No.: 16/086,466

(22) PCT Filed: Apr. 3, 2017
(86) PCT No.: PCT/US2017/025674

§ 371 Date: Sep. 19, 2018

Related U.S. Application Data
(60) Provisional application No. 62/319,555, filed on Apr. 7, 2016.

(51) Int. Cl. B23B 31/02; B23B 31/177

(52) U.S. Cl. CPC B23B 31/025; B23B 31/26; B23B 31/16266

(57) ABSTRACT

A workholding apparatus (2) having jaws (5) comprising interchangeable adapter blocks (12) that enable a single workholding apparatus (2) to accommodate workpieces (22) having a range of inner bore diameters.

### FIELD OF THE INVENTION

The present invention is directed workholding equipment. Specifically, the present invention discloses a workholding apparatus for securing and releasing a gear workpiece in a machine tool.

### BACKGROUND OF THE INVENTION

In metalworking operations where a workpiece is machined, equipment of some type is necessary to hold the workpiece in position in a machine tool so the machining process can be successfully carried out. This type of equipment is known as “workholding” equipment. In the production of toothed articles, such as gears, workholding equipment can be generally categorized as two types, chucks and arbors.

Chucks hold a workpiece by contracting a component called a “collet” around the workpiece or a component thereof. For example, when a bevel or hypoid pinion with integral shaft is placed in a chuck, it is usually the shaft that is gripped by the collet which has been reduced in diameter (i.e. contracted) to grip the shaft to hold the pinion in position for machining. Examples of chucks for gripping pinion shanks can be found in U.S. Pat. Nos. 3,083,976 to Stark and U.S. Pat. No. 3,244,427 to Taschl.

Arbors grip a workpiece by expanding a collet into contact with a surface of the workpiece. As an example, a bevel ring gear is placed on an arbor and the collet is expanded until contact of sufficient force is established with the surface of the bore of the ring gear to hold the ring gear in position during machining. An example of an arbor for a ring gear can be found in U.S. Pat. No. 3,735,994 to Jaehn. An arbor for expanding into contact with the bore of a pinion can be found in U.S. Pat. No. 3,517,939 to Jaehn.

In either chucks or arbors, the force necessary to contract or expand the collet mechanism is provided by a draw bar (or draw rod) in the machine tool. The draw rod is advanced and/or retracted usually via a hydraulically operated piston. Movement of the draw rod in the axial direction of the chuck or arbor usually causes opposed angled surfaces of components within the workholding equipment to slide relative to one another resulting in inward (contracting) or outward (expanding) movement of the collet to grip a workpiece or component part thereof. Generally, one angled surface is found on the collet and the other angled surface is found on an actuator attached to the draw rod or on the draw rod itself.

Chucks and arbors are mounted for rotation in the bore of a spindle of a machine tool. The spindle bore is usually tapered and a similar taper is usually found on the outer surface of the chuck or arbor. In some instances, a reducing sleeve may be included between the chuck or arbor and the spindle bore. Once placed in the spindle bore, a plurality of bolts are extended through holes in a mounting flange, located about the spindle, and into engagement with corresponding threaded holes in the face of the machine spindle. Alternatively, tool-less types of workholding are known wherein no mounting bolts are utilized and such chucks and arbors can be installed and removed without the use of tools.

It is common to manufacture thousands of the same workpiece such as certain gears for the automotive industry. With this type of production, the requirements for workholding equipment would not change and the same size of chuck or arbor would be sufficient for the entire production run. However, there are other situations, such as a job shop, gear development laboratory or prototyping, for example, where small batches, even one or two, of different size gears are produced as a matter of routine. With this type of production, several sizes of workholding equipment are required in order to accommodate the varying sizes of gears. The need for a large inventory of workholding results in significant expense.

Additionally, lead times for workholding equipment can be long, on the order of many weeks. Small batch production and/or laboratory and prototyping environments cannot wait many weeks for appropriate workholding equipment. There is a need for workholding equipment that can be produced with shorter lead times and at less expense.

### SUMMARY OF THE INVENTION

The invention is directed to a workholding apparatus having jaws comprising interchangeable adapter blocks that enable a single workholding apparatus to accommodate workpieces having a range of inner bore diameters.

The invention is further directed to a workholding arbor for holding gear workpieces for processing on a gear processing machine with the arbor being rotatable about an axis of rotation. The arbor comprises an arbor body having an axial outer end portion for releasably mounting of a gear workpiece and an axial inner end portion insertable into a gear processing machine. The arbor further comprises a backing plate located at the outer end and an expander located within the arbor body with the expander being movable axially and in opposite directions along the axis of rotation. The arbor includes a plurality of jaws adjacent to the backing plate with the jaws being movable radially toward and away from the axis of rotation with each jaw comprising an expanding wedge and an adapter block having a radial length. The adapter block is located radially outward of and removably attached to each of the expanding wedges and is radially movable therewith. The arbor further includes at least one resilient means attached to each of the adapter blocks with the at least one resilient means exerting a force to urge movement of the adapter blocks in a radially inward direction.

### BRIEF DESCRIPTION OF THE DRAWINGS

FIG. 1 is an axial cross-section of an arbor according to the invention.

FIG. 2 is a front view of the arbor of FIG. 1 without a workpiece.

FIG. 3 is a front view of the arbor of FIG. 1 without a workpiece and chip guard.

FIG. 4 illustrates adapter blocks of different radial lengths on the arbor of FIG. 3.

### DETAILED DESCRIPTION OF THE PREFERRED EMBODIMENT

The terms “invention,” “the invention,” and “the present invention” used in this specification are intended to refer broadly to all of the subject matter of this specification and any patent claims below. Statements containing these terms should not be understood to limit the subject matter described herein or to limit the meaning or scope of any patent claims below. Furthermore, this specification does not seek to describe or limit the subject matter covered by any claims in any particular part, paragraph, statement or drawing of the application. The subject matter should be understood by reference to the entire specification, all drawings and any claim below. The invention is capable of other constructions and of being practiced or being carried out in various ways. Also, it is understood that the phraseology and terminology used herein is for the purposes of description and should not be regarded as limiting.

The details of the invention will now be discussed with reference to the accompanying drawings which illustrate the invention by way of example only. In the drawings, similar features or components will be referred to by like reference numbers. Although references may be made below to directions such as upper, lower, upward, downward, rearward, bottom, top, front, rear, etc., in describing the drawings, there references are made relative to the drawings (as normally viewed) for convenience. These directions are not intended to be taken literally or limit the present invention in any form.

The use of “including”, “having” and “comprising” and variations thereof herein is meant to encompass the items listed thereafter and equivalents thereof as well as additional items.

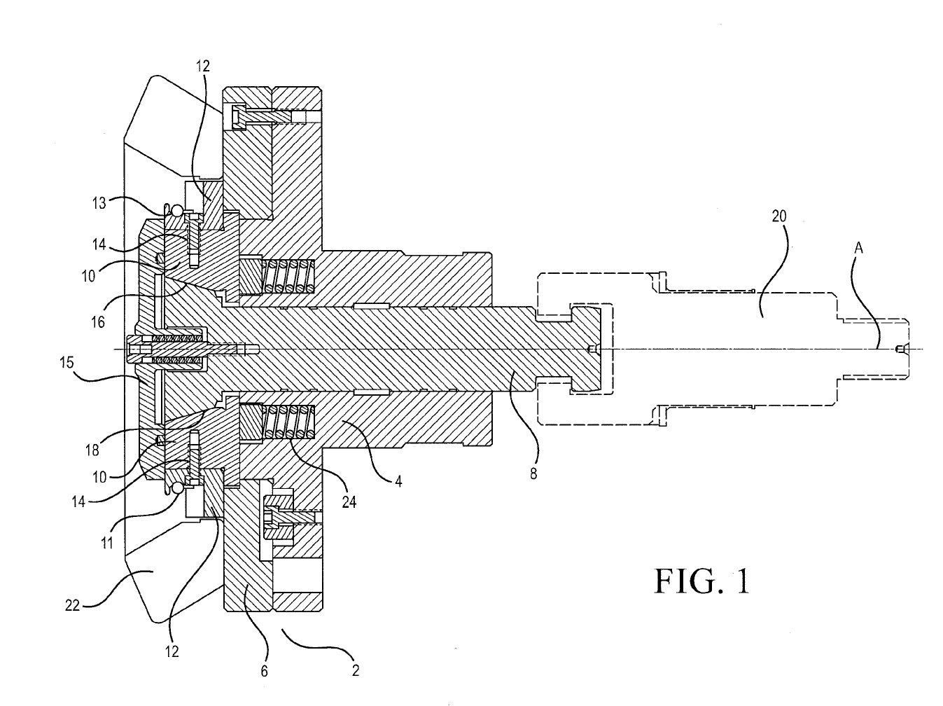

FIG. 1 shows a workholding apparatus in the form of an expanding arbor 2 for releasably securing a workpiece, such as a bevel ring gear workpiece (either blank or having teeth), in a spindle of a machine tool for processing (e.g. cutting, grinding, hard skiving, lapping, testing, metrology, etc.). Machine tools for processing gears are well known (e.g. U.S. Pat. No. 6,712,566 to Stadtfeld et al.) and no further detailed explanation of such machines is believed necessary in order for the present invention to be understood by the skilled artisan.

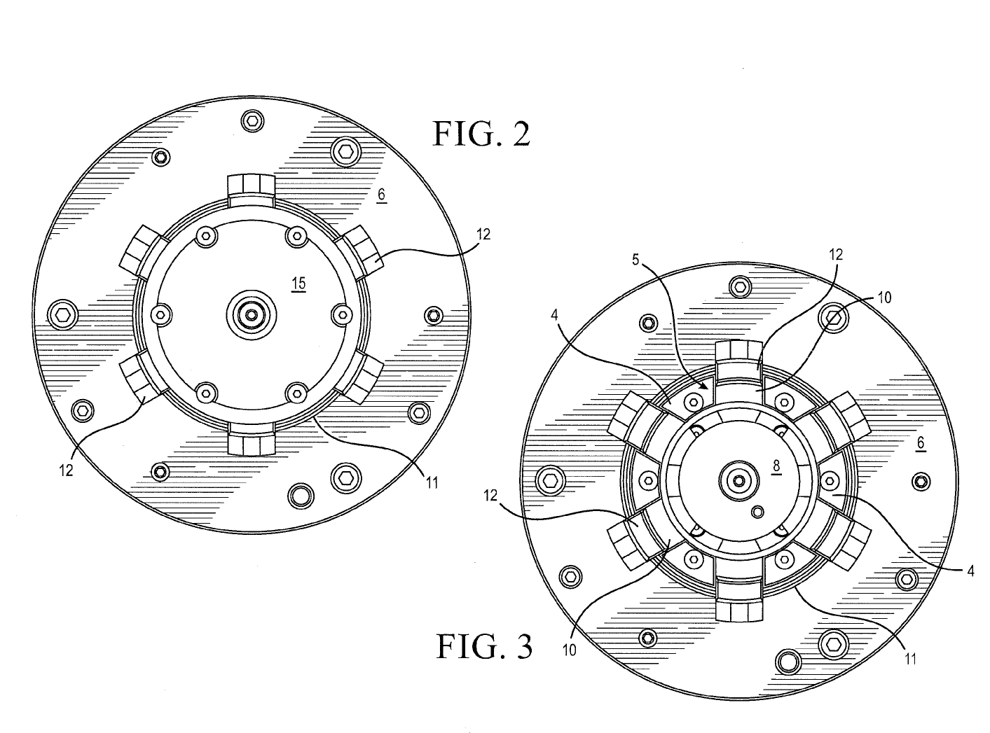

Arbor 2 is rotatable about an axis of rotation, A, and comprises an arbor body 4, backing ring or plate 6, expander 8 and a plurality jaws 5 (FIG. 3) with each jaw comprising an expanding wedge 10 and an adapter block 12. Adapter block 12 is releasably attached to a respective expanding wedge 10 (FIG. 3) preferably via screws 14 although any suitable method of releasably securing the adapter blocks to the expanding wedges may be utilized. Therefore, it is evident that the number of jaws 5, expanding wedges 10 and adapter blocks 12 are the same. Preferably, arbor 2 includes at least three, and more preferably six, jaws. The axially outer portions of the expander 8 and the expanding wedges 10 are preferably covered by a chip guard 15 (also seen in FIG. 2).

The expander 8 includes a first end having an angled surface 16 which is movable, in a sliding manner, along a complementary angled surface 18 of each of the expanding wedges 10 which are held in contact with the expander 8 via one or more resilient means, such as a spring 11, which resides in a groove 13 on each adapter block 12. Therefore, a spring, preferably a single generally circular spring 11, extends about all the adapter blocks 12 and, indirectly, about all the expanding wedges 10. The other (inner) end of expander 8 is in releasable communication with a machine draw rod (not shown) via a draw rod connector 20 (shown in phantom lines).

Rearward movement (to the right in FIG. 1) of the expander 8 along axis A causes angled surface 16 to slide along the angled surface 18 of each expanding wedge 10 thereby causing the expanding wedges and their respective adapter blocks 12 to move radially outward (i.e. expand) into contact with an inner surface of a workpiece which, in FIG. 1, is a bevel gear blank 22. At the same time, compression springs 24 enable the back surface of a workpiece to seat securely against backing ring 6, to ensure precision, as the expander moves rearward. Once the motion of the expander stops, the workpiece is clamped (shown in FIG. 1) and machining of the workpiece may commence.

To release a workpiece subsequent to machining, expander 8 is moved forward (to the left in FIG. 1) along axis A thereby causing angled surface 16 to slide along the angled surface 18 of each expanding wedge 10 in the direction opposite to that of clamping. Such motion enables the expanding wedges 10 and their respective adapter blocks 12 to move radially inward due to the contracting force of spring 11.

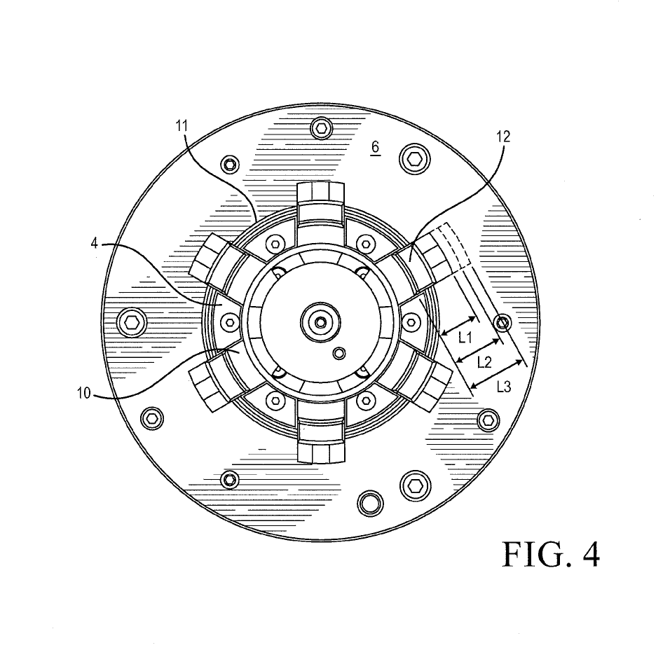

With the arbor of the invention, workpieces of different inner diameters can be accommodated by utilizing bolt-on, interchangeable adapter blocks 12 manufactured to different radial lengths (i.e. different lengths in the radial direction of the drawings) as shown, for example, in FIG. 4 by lengths L₁, L₂ and L₃. Therefore, a single arbor can accommodate a range of workpiece inner bore sizes by changing adapter blocks 12. Also, one backing ring 6 can be used for a wider range of gear diameters. These features are a departure from the limitations of known workholding equipment wherein a collet and backing ring were individually designed for the exact dimensions of a specific gear.

As discussed, the inventive arbor can accommodate a range of workpiece inner bore sizes. For example, an arbor may cover workpiece bore diameters in the range of 4.250-5.000 inches (108-127 mm). Another larger arbor may cover workpiece bore diameters in the range of 5.001-6.500 inches (127-165 mm) and an even larger arbor may cover workpiece bore diameters in the range of 6.501-8.000 inches (165-203 mm). Thus it can be seen that a set of three arbors may provide workholding capabilities for workpiece bore diameters in the range of 4.250-8.000 inches (108-203 mm). Workpiece bore diameters less than and/or greater than those of the above examples are also contemplated.

While the invention has been described with reference to preferred embodiments it is to be understood that the invention is not limited to the particulars thereof. The present invention is intended to include modifications which would be apparent to those skilled in the art to which the subject matter pertains without deviating from the spirit and scope of the appended claims.

What is claimed is:

1. A workholding arbor for holding gear workpieces for processing on a gear processing machine, said arbor being rotatable about an axis of rotation and comprising:
an arbor body having an axial outer end portion for releasably mounting of a gear workpiece and an axial inner end portion insertable into a gear processing machine,
a backing plate located at the outer end,
an expander located within the arbor body, said expander being movable axially and in opposite directions along said axis of rotation,
a plurality of jaws adjacent said backing plate, said jaws being movable radially toward and away from said axis of rotation with each jaw comprising an expanding wedge,
each jaw further comprising an adapter block having a radial length, said adapter block being located radially outward of and removably attached to each of said expanding wedges and being radially movable therewith,
at least one resilient means attached to each of said adapter blocks, said at least one resilient means exerting a force to urge movement of said adapter blocks in a radially inward direction.

2. The workholding arbor of claim 1 wherein said at least one resilient means comprises a spring.

3. The workholding arbor of claim 1 wherein said spring comprises a generally circular spring.

4. The workholding arbor of claim 1 further comprising a chip guard located axially outward of said expanding wedges.

5. The workholding arbor of claim 1 wherein the adapter blocks are interchangeable with adapter blocks having different radial lengths whereby a single arbor can accommodate a range of gear workpiece inner bore sizes.

6. The workholding arbor of claim 5 wherein said backing plate remains unchanged with respect to said range of gear workpiece inner bore sizes.

7. The workholding arbor of claim 1 wherein said expander includes a first end at said outer portion of said arbor, said first end having an angled surface which is movable in a sliding manner along a complementary angled surface of each of said expanding wedges, whereby axial movement of said expander in a direction from said outer portion toward the inner end portion of said arbor moves said expanding wedges and said adapter blocks radially outward.

8. The workholding arbor of claim 7 wherein axial movement of said expander in a direction from said inner end portion toward said outer end portion of said arbor results in said at least one resilient means exerting a force to urge said adapter blocks and said expanding wedges radially inward.

9. The workholding arbor of claim 1 wherein said gear workpiece comprises a bevel ring gear.

10. The workholding arbor of claim 1 wherein said gear processing machine comprises a gear cutting machine, a gear grinding machine, a gear testing machine or a gear metrology machine.
